(19) United States
(12) Patent Application Publication
(10) Pub. No.: US 2024/0398516 A1
(43) Pub. Date: Dec. 5, 2024

(54) OSSEODENSIFICATION DEVICE FOR DENTAL IMPLANTS

(71) Applicant: Argimiro Antonio Hernández Suarez, Mairena del Aljarafe (SEVILLA) (ES)

(72) Inventor: Argimiro Antonio Hernández Suarez, Mairena del Aljarafe (SEVILLA) (ES)

(21) Appl. No.: 18/522,415

(22) Filed: Nov. 29, 2023

(30) Foreign Application Priority Data
Nov. 30, 2022 (ES) U202232010

(51) Int. Cl. A61C 8/00

(52) U.S. Cl. CPC A61C 8/0092

(57) ABSTRACT

Osseodensification device for dental implants, consisting of a device that, through osseodensification techniques, allows the drilling and compaction of the alveolar bone for carrying out dental implants in the jaw or mandible. It comprises a rotary tool that turns a dental drill fitted with interchangeable cutting grooves of different diameters (in mm): 2.0, 2.3, 2.5, 2.8, 3.0, 3.3, 3.5, 3.8, 4.0, 4.3 and 4.5, the drills in turn having a maximum length of 31 mm, and the maximum length of the active part of 16 mm, of great accessibility to the bottom of the oral cavity. Rotation of the drill in a clockwise direction causes osseodensification by depositing on 10 the walls and at the apex of the osteotomy, elevating the floor membrane of the maxillary sinus by means of hydropneumatic pressure filling the floor of the sinus with material.

### OBJECT

The present invention relates to a device that, by means of osseodensification techniques, allows the drilling and compaction of the alveolar bone for performing dental implants in the jaw or mandible.

For this reason, the object of the present invention will be of interest to the surgical material industry in the dental sector.

### STATE OF THE ART

Osseodensification is a technique without bone extraction, which began to be developed a decade ago, through the use of drills specially designed to increase bone density, as they expand an osteotomy.

Drills can work in two directions. In a non-cutting inverted direction (osseodensifying mode) that with abundant irrigation allows the formation of a dense compacted layer of bone tissue along the walls and base of the osteotomy. This clockwise system to achieve bone densification and compact bone tissue (but it is clockwise, counterclockwise would be an important advantage for cutting, than the difference of the first system (VERSAH)

Standard drill bits were previously used that when removing bone generated tensions that could reach or exceed the threshold of bone microdestruction, with the consequence that a bone remodelling needed more than 3 months to repair the damaged area.

Unlike such traditional bone drilling technologies, osseodensification does not excavate bone tissue. Osseodensification is achieved by taking advantage of the properties of the bone, such as its plasticity, the variation of its structural properties according to its location (inhomogeneous), as well as the variability of its biomechanical properties depending on the direction in which the force is applied (anisotropy).

With the present osseodensification device for dental implants, osseodensification, bone expansion and maxillary sinus elevation can be achieved, obtaining easy and durable placement of dental implants.

For the application of these drills essentially designed for osseodensification, different inventions are known, among which the following can be mentioned.

European patent EP 2027829 entitled “Dental drill guide with a stop” of 03.07.2008, of the Swiss company STRAUMANN HOLDING AG, describes a dental drill guide with a stop for use in the dental field. This explains how the holes are made in several steps in most implant procedures. For example, the first hole is made with a pilot dental drill of reduced diameter, followed by drilling with a spiral dental drill with a definitive diameter of the implant to be placed. Depending on the procedure, other dental drills with intermediate diameters or other cutting geometries may also be required.

Likewise, some of the difficulties to be overcome in these surgical acts are described, such as that, because the reduction bushes are also changed during treatment and they usually have diameters of less than 6 mm, there are difficulties in handling and even the danger of aspiration by the patient. In turn, an additional problem is that the drill should not penetrate too deep into the bone since, otherwise, nerves could be affected.

The present osseodensification device for dental implants avoids the use of the aforementioned bushes that could be aspirated by the patient and in turn prevents too deep penetration into the bone, as the drills have a stop.

On the other hand, European patent EP 3366256 of 13.05.2020 of the German company FRANK ZASTROW describes a device for guiding a dental surgical hollow cutter.

Said patent describes a device for guiding a dental surgical hollow drill during a bone extraction, with a template that can be fixed in the area of an extraction point and at least one guide means arranged on the template, the guide means guiding the hollow drill in such a way that only a part of the distal edge of the hollow drill can contact the bone and the hollow drill can be guided by the guide means laterally by the bone, so that a piece of bone in the form of a circular segment can be separated.

This patent highlights the difficulties for dentists and maxillofacial surgeons to work in the oral cavity, due to the lack of space, so the size of the surgical instruments used is essential to be able to perform the medical act in appropriate conditions.

This osseodensification device for dental implants allows the use of smaller dental drills that facilitate their use in osseodensification techniques.

Therefore, this invention is an improvement over existing devices, thus representing an advance in the state of the art regarding these types of devices.

### DESCRIPTION

This osseodensification device for dental implants is formed by a rotary tool that rotates a dental drill, of the type used in dentistry in osseodensification procedures.

The dental drill is specially designed to increase bone density, as they expand an osteotomy, prior to a surgical procedure to place a dental implant.

The drills have helical grooves in the form of grooves with cutting edges, characterized in that the device comprises a set of exchangeable dental drills of at least the following diameters (in mm): 2.0, 2.3, 2.5, 2.8, 3.0, 3.3, 3.5, 3.8, 4.0, 4.3 and 4.5, which allows greater control of bone expansion and better osseodensification, the drills in turn having a maximum length of 31 mm, and the maximum length of the active part of 16 mm, of great accessibility to the bottom of the oral cavity.

This is a remarkable advantage, considering that implants are most often performed in low-density bones and these are most likely to be found in the posterior sector, where there is a limitation of the oral opening and the possibility of reaching that area is limited by the length of the drill used.

Likewise, it can be placed more parallel to the axial axis of the area allowing a better preparation of the surgical bed and therefore a better three-dimensional location of the implant to be placed in the area

On the other hand, the grooves of the drills are oriented so that the rotation of the drill in a clockwise direction produces osseodensification by depositing on the walls and at the apex of the osteotomy, elevating the floor membrane of the maxillary sinus by means of hydropneumatic pressure filling the floor of the sinus with autologous material.

This avoids the traditional counterclockwise twisting work for cutting followed by clockwise work for bone condensation.

This is one of its great advantages, since traditional drilling systems work clockwise as subtractive methods (they extract bone to leave room for the implant) and counterclockwise to prepare the bone for the implant, which means that the operator must be changed from a clockwise to a counterclockwise system during the surgical procedure, which is cumbersome and sometimes leading to involuntary errors.

In this way, the osseodensification device for dental implants allows to work in a simpler way, eliminating the possible errors and complications associated with this surgical act

### PREFERRED EMBODIMENT OF THE INVENTION

A detailed description is given below of the osseodensification device for dental implants, in an exemplary embodiment. These drawings illustrate:

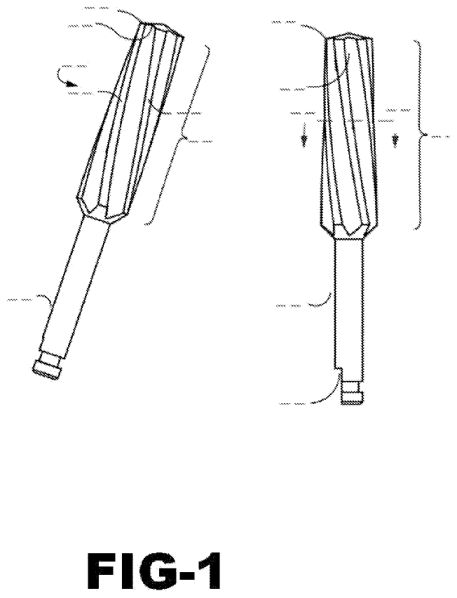

In FIG. 1: An image of an osseodensification drill of the osseodensification device for dental implants is presented.

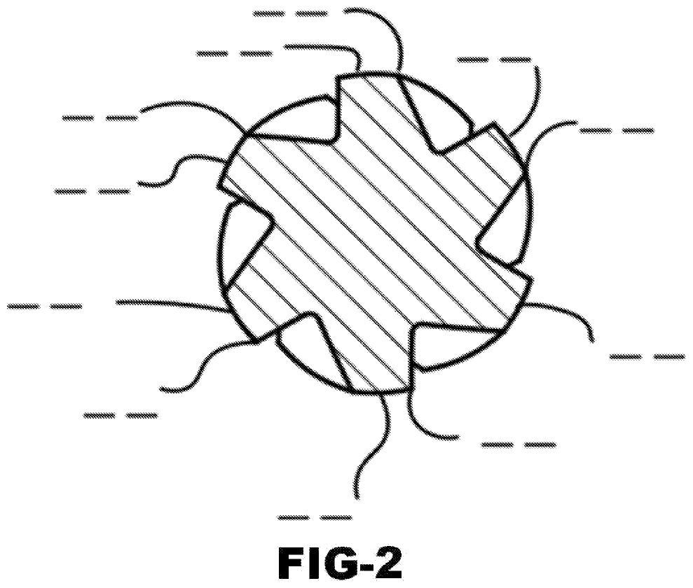

In FIG. 2: An axial section of an osseodensification drill of the osseodensification device for dental implants is presented.

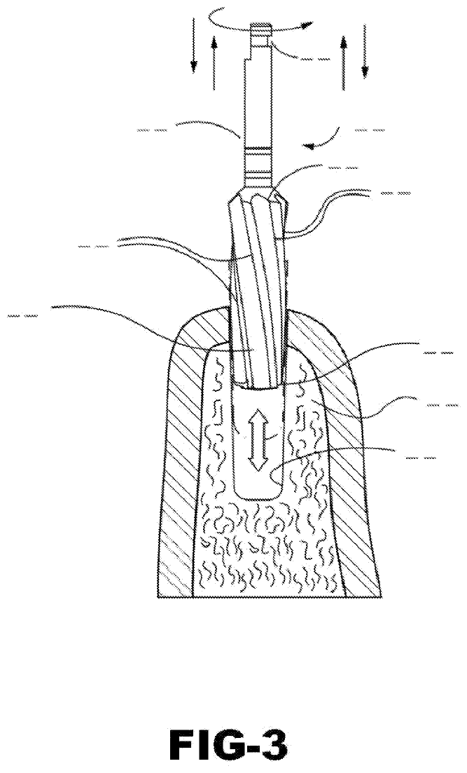

In FIG. 3: A diagram of the clockwise rotational movement and use of an osseodensification drill in the pumping direction of the osseodensification device for dental implants is presented.

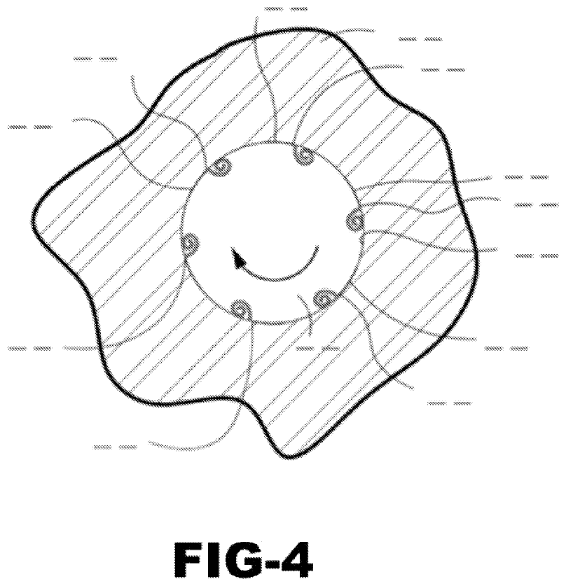

In FIG. 4: An image of an axial section of the densification effect on the bone of an osseodensification drill of the osseodensification device for dental implants is presented.

According to the depicted embodiment, the osseodensification device for dental implants is constituted by a rotary tool that turns a dental drill, of the type used in dentistry in osseodensification procedures, specially designed to increase bone density, as they expand an osteotomy, prior to a surgical procedure for placing a dental implant, where the drills have helical grooves in the form of grooves with cutting edges.

In this example, the device comprises a set of interchangeable dental drills of at least the following diameters (in mm): 2.0, 2.3, 2.5, 2.8, 3.0, 3.3, 3.5, 3.8, 4.0, 4.3 and 4.5, which allows greater control of bone expansion and better osseodensification, the drills in turn having a maximum length of 31 mm, and the maximum length of the active part of 16 mm, of great accessibility to the bottom of the oral cavity.

This is a remarkable advantage, considering that implants are most often performed in low-density bones and these are most likely to be found in the posterior sector, where there is a limitation of the oral opening and the possibility of reaching that area is limited by the length of the drill used.

Likewise, it can be placed more parallel to the axial axis of the area allowing a better preparation of the surgical bed and therefore a better three-dimensional location of the implant to be placed in the area

In this example, the grooves of the drills are oriented so that the rotation of the drill in a clockwise direction produces osseodensification by depositing on the walls and at the apex of the osteotomy, elevating the floor membrane of the maxillary sinus by means of hydropneumatic pressure filling the floor of the sinus with autologous material.

This avoids the traditional counterclockwise twisting work for cutting followed by clockwise work for bone condensation.

This is one of its great advantages, since traditional drilling systems work clockwise as subtractive methods (they extract bone to leave room for the implant) and counterclockwise to prepare the bone for the implant, which means that the operator must be changed from a clockwise to a counterclockwise system during the surgical procedure, which is cumbersome and sometimes leading to involuntary errors.

In this way, the osseodensification device for dental implants allows to work in a simpler way, eliminating the possible errors and complications associated with this surgical act

And lastly, the shape, materials and dimensions may be variable, as may, in general, everything that is accessory and secondary, provided that it does not alter or modify the essential nature of the improvements described herein.

1. Osseodensification device for dental implants, consisting of a rotary tool that turns a dental drill, of the type used in dentistry in osseodensification procedures, specially designed to increase bone density, as they expand an osteotomy, prior to a surgical procedure for placing a dental implant, where the drills have helical grooves in the form of grooves with cutting edges, characterized in that the device comprises a set of interchangeable dental drills of at least the following diameters (in mm): 2.0, 2.3, 2.5, 2.8, 3.0, 3.3, 3.5, 3.8, 4.0, 4.3 and 4.5, the drills in turn having a maximum length of 31 mm, and the maximum length of the active part of 16 mm, of great accessibility to the bottom of the oral cavity.

2. Osseodensification device for dental implants, according to the first claim characterized in that the grooves of the drills are oriented so that the rotation of the drill in a clockwise direction produces osseodensification by depositing on the walls and at the apex of the osteotomy, elevating the floor membrane of the maxillary sinus by means of hydropneumatic pressure filling the floor of the sinus with autologous material.
